(19) United States
(12) Patent Application Publication
(10) Pub. No.: US 2003/0145086 A1
(43) Pub. Date: Jul. 31, 2003

(54) Scalable network-attached storage system

(76) Inventor: James O'Reilly, Riverside, CA (US)

Correspondence Address: James O'Reilly, 18400 Kross Rd, Riverside, CA, 92508, US

(21) Appl. No.: 10/058,242

(22) Filed: Jan. 29, 2002

(51) Int. Cl. G06F 15/173

(52) U.S. Cl. 709/226

(57) ABSTRACT

A Scalable Network-Attached Storage system, a Secure Scalable Network-Attached Storage system and a Peer-Based Storage Network all with high performance and scalability are described by this invention, which uses Dynamic Access Distribution to avoid scaling penalties.

### CROSS-REFERENCE TO RELATED APPLICATIONS

None

### STATEMENT REGARDING FEDERALLY SPONSORED RESEARCH OR DEVELOPMENT

No Federal funds were used to design or develop any parts of this invention.

### BACKGROUND OF THE INVENTION

Network-Attached Storage (NAS) systems available in the marketplace today all suffer from a throughput bottleneck caused by their inability to expand the number of computer modules used to move data from storage to the Local Area Network. Industry attempts to resolve this problem hinge around sophisticated file systems, variously described as “global file systems”, “distributed file systems” or “locking file systems”. All of these methods have so far proved unusable, since the requirement to maintain exactly synchronized copies of the file system impose very severe performance penalties.

This document details a solution using a completely different and novel method of managing the stored data. This method overcomes the bottleneck problem elegantly, permitting not only broad scaling of a NAS system but adding the ability to insert or remove computer modules rapidly and to protect against failure of such modules.

A further elegance of this approach is that it can be applied to many NAS products sold today to add scaling and fault-tolerant features to those products. An enhancement of the invention will allow peer computers (such as Personal Computers and servers) in a network to share their storage in an organized and highly available way, which is a valuable capability since storage drive capacities are becoming very large.

### BRIEF SUMMARY OF THE INVENTION

The invention, Scalable Network-Attached Storage (SNAS), addresses a number of problems inherent to current approaches to NAS systems, which are a type of computer system that present storage space to a client user via a Local Area Network (LAN) in such a way that the user sees all or part of the storage as an addressable disk drive

The specific problems addressed by this invention are

1) Scalability of both the storage and the throughput of the LAN interface to that storage, while maintaining high performance,

2) Fail-over of the LAN interface elements,

3) Protection against data loss,

4) Automated response to changes in demand,

5) Creation of Secure-SNAS elements,

6) The creation of Peer-Based Storage Networking, where the rapid growth in the size of disk drives is utilized to allow computers to provide storage to their peer computers.

In contrast to existing approaches, the invention uses a means of dynamic access allocation distribution to achieve solution of the problems, whereby any given computer element is allocated control of a portion of the storage space based on usage or other performance metrics. This means that there is no need to lock or synchronize the file systems in all of the elements, which creates very severe performance problems in the existing approaches.

The invention also provides a means to extend these solutions to create peer-based storage networks. This is a new opportunity, which takes advantage of the extremely rapid growth in storage disk drive capacities that is occurring.

### BRIEF DESCRIPTION OF THE SEVERAL VIEWS OF THE DRAWINGS

There are 15 Figures attached to this application. Briefly, these are:

FIG. 1: A view of current NAS systems with tightly coupled computer elements, showing the limited scalability of such systems. Here the number of computer elements and data storage elements in the NAS system are severely limited.

FIG. 2: A view of current NAS systems using an alternative loosely coupled construction with a shared file system on each computer element. This view shows a typical implementation with a lockbox element configured in the system to attempt to accelerate operations and overcome the severe performance penalty of the shared file system.

FIG. 3 shows a preferred implementation the Scalable Network Attached Storage system made possible by this invention. (For drawing purposes the depiction is limited in the number of elements and client computers shown) The figure shows a mixture of shared and exclusively owned data storage elements, all of which are made to appear as a cohesive data set by the SNAS system.

FIG. 4 shows a possible installation of the various software elements of the invention on the preferred implementation.

FIG. 5 demonstrates the data storage element mapping method for a typical computer system environment, showing a typical example of the three levels of mapping: as the client computer sees the file system; as the SNAS system allocates access to the data storage elements and as implemented on physical story.

FIG. 6 is similar to FIG. 5 but reflects how a record-oriented database system might be mapped in an SNAS environment. Here the mapping is more flexible, since the primary data element is a relatively small and independent data record.

FIG. 7 shows the two-tier mapping system for free space on the SNAS system, where part of the free space is allocated to specific computer elements, and the remainder allocated by the Dynamic Allocation Controller (DAC) function which adds or subtracts free space from the computer elements as controlled by policy rules.

FIG. 8 demonstrates the adding of a new (or failure recovered) computer element to the SNAS system. There are two sub-figures, showing a typical element map just as the new computer element is added and then after the DAC has executed a re-mapping to handle the new element, where access control for some data storage elements is moved to the new computer element.

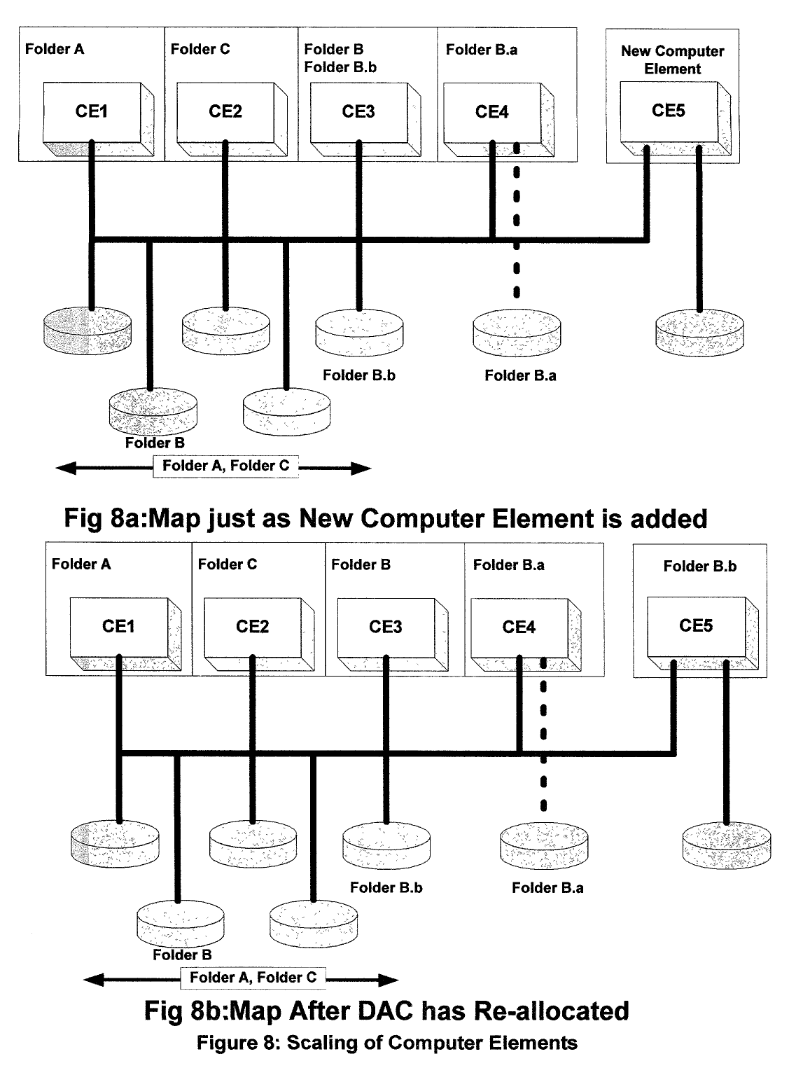

FIG. 9 shows how the operation of the backup mapping system might operate to reduce the time that a given data storage element is unavailable, by more rapidly allowing another computer element to take over the control of those data storage elements formerly handled by the failed computer element.

FIG. 10 demonstrates local data replication where the policy rule system initiates a replication operation between one computer element and another. In this case the replication is shown to occur over the Local Area Network, but alternative implementations might use the Storage Area network or other pathways.

FIG. 11 similarly shows replication, but here the pathway is through Wide Area Network communications equipment, allowing a copy of data to be replicated on a distant site for added disaster protection.

FIG. 12 shows an example of access replication, where more than one computer element is allowed to access any given data element, so permitting a substantial increase in the number of accesses n a given time to that data storage element. In this example, only one computer element is write-enabled to allow the data storage element to be changed, but the SNAS system allows for multiple change-enabled computer elements if the data type or file users allow it.

FIG. 13 shows an extension of the SNAS concept whereby a portion of the SNAS might be segregated and communicated with using encryption. Data Encryption Agents (DEA) are shown in a number of the elements including several client computers.

FIG. 14 portrays a typical Peer-Based Storage Network, where the SNAS means are extended to allow the unused storage of peer client computers and other computers to be used in concert with the SNAS and Secure-SNAS systems to enhance performance and reduce overall systems costs.

FIG. 15 shows how the Peer-Based Storage Network might be employed to protect important data, so allowing a High-Availability User Network to be built. Here multiple copies of an important file are distributed across the network and SNAS system.

FIG. 16 shows an alternative construction of a SNAS, Secure-SNAS or Peer-Based Storage Network, where a network switch is used as the vehicle for re-directing accesses from the client computers. Other alternative constructions similar to this might put the re-direction functions in a storage network switch or in a hybrid switch containing both storage and communications networking functions.

### DESCRIPTION OF THE INVENTION

### Overview

As noted in the Brief Description above, this invention solves a number of problems seen in today's NAS systems. These are:

1) Scalability of both the storage and the throughput of the LAN interface to that storage, while maintaining high performance,

2) Fail-over of the LAN interface elements,

3) Protection against data loss,

4) Automated response to changes in demand,

5) Creation of Secure-NAS elements,

6) The creation of Peer-Based Storage Networking, where the rapid growth in the size of disk drives is utilized to allow computers to provide storage to their peer computers.

NAS systems typically consist of one or more computer elements that interface between the storage disk drives and the LAN. This invention, Scalable Network-Attached Storage (SNAS) resolves the above problems by means of dynamically allocating control of the data storage elements (Drives, logical volumes, folders/directories, files or blocks) to the various computer elements. The allocation process uses a variety of algorithmic policy rules to determine the ownership of each data element, including rules involving the size of the data storage element, frequency of access, type of data stored, level of availability guaranteed to the users, security and disaster backup needs. Control of the allocation process resides in one or more of the computer elements, together with, or instead of, their SNAS functions.

Using the allocation policies, the invention distributes the totality of the storage elements to the various computer elements. This distribution is reviewed on a regular basis and adjusted as required. The invention can be tailored to work with a broad variety of storage file systems and existing NAS software. A key requirement is that a computer element must be able to view that part of the storage allocated for its control, but visibility of any other part of the storage system will not impact on the normal operation of the invention, and in many cases is desirable as a means to speed up recovery processes in the event of a computer element failure.

The invention allows sophisticated segmentation of the storage, whereby sections of the storage can be replicated invisibly to the client user to add protection. This replication can be local to the storage system, or over a data communications link to protect against disaster loss of information. At the same time, the number of computer elements allocated to a given data element can be adjusted. Adding new computer or storage elements is also simple and automatic, since the allocation policy managers will utilize the new assets upon detection by readjusting the allocations.

This flexibility in managing storage by access is extended to utilize the very large storage elements becoming common on Personal Computers and other computers. A Peer-Based Network Storage solution uses part of the available storage on each computer as a Distributed SNAS. This requires dynamic management of the storage and replication services, which the invention provides. However, the policy rules management element of the invention is extended to manage the physical placement of data on the Distributed SNAS, in like manner to the methods used to place data by policy in the SNAS implementations of the invention.

### Comparison with Current Methods

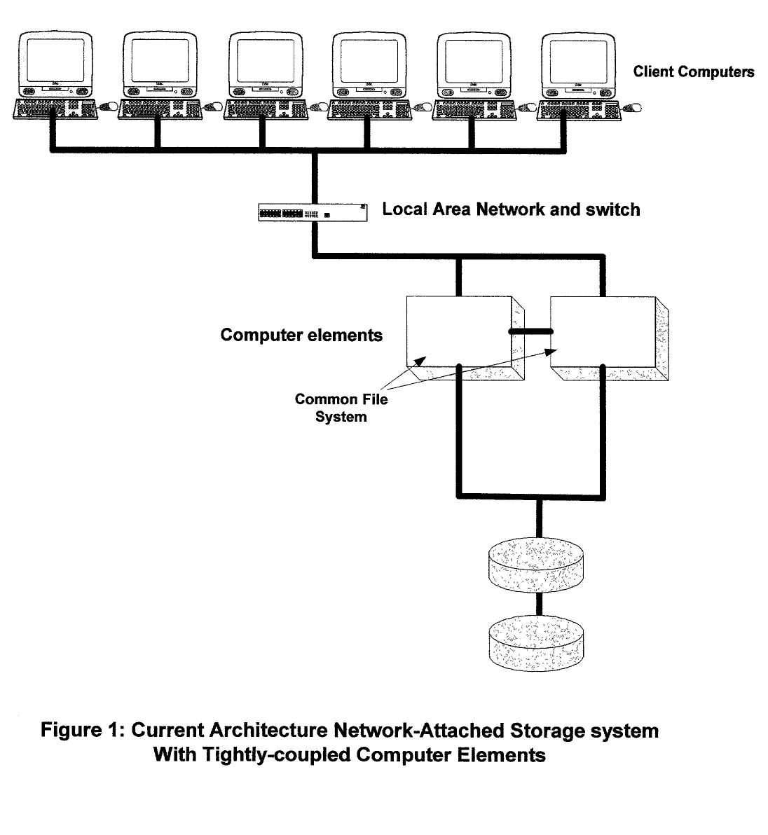

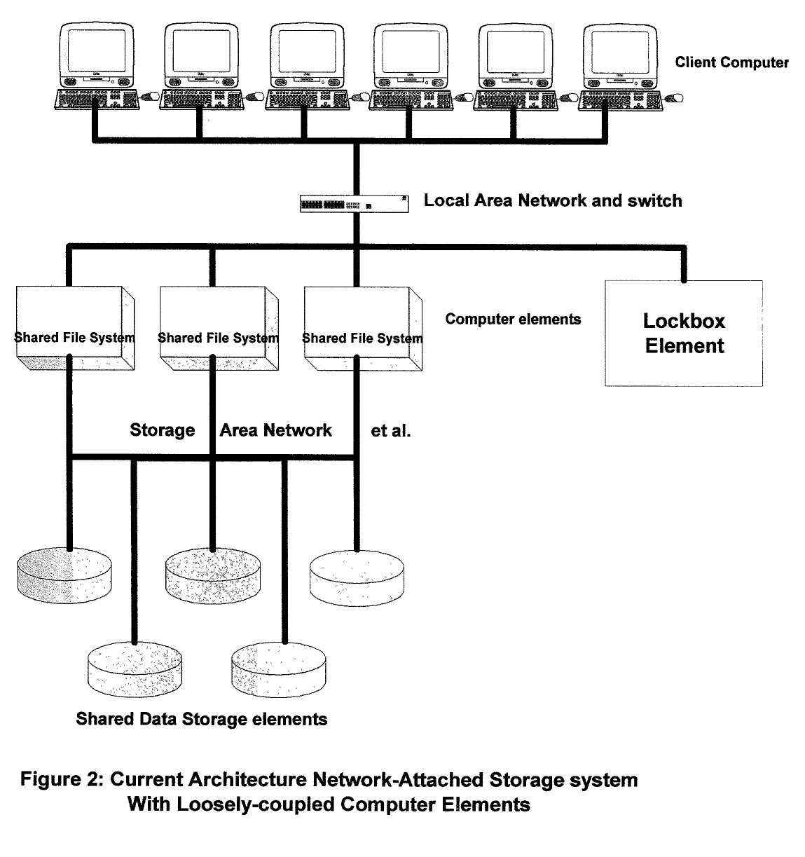

The SNAS invention uses a very different method compared with the methods used in computers or existing NAS systems. In multi-processor computer systems, either a single file system or a global file system is used; depending respectively on whether the structure of the computer cluster is considered tightly coupled or loosely coupled. In the tightly coupled case (see FIG. 1), the computers access a single image of the file system kept on the data storage elements, and so the computers behave essentially as a single entity in controlling that storage. The need to maintain a “single computer image” creates a very expensive design that is limited in scalability, difficult to change and less resistant to failures. The alternative loosely coupled architecture (FIG. 2) treats the computers as relatively independent units. To maintain the integrity of the shared data storage while allowing any of the computers to access any part of that data storage, the system designer resorts to a shared file system (also described as a distributed or global file system).

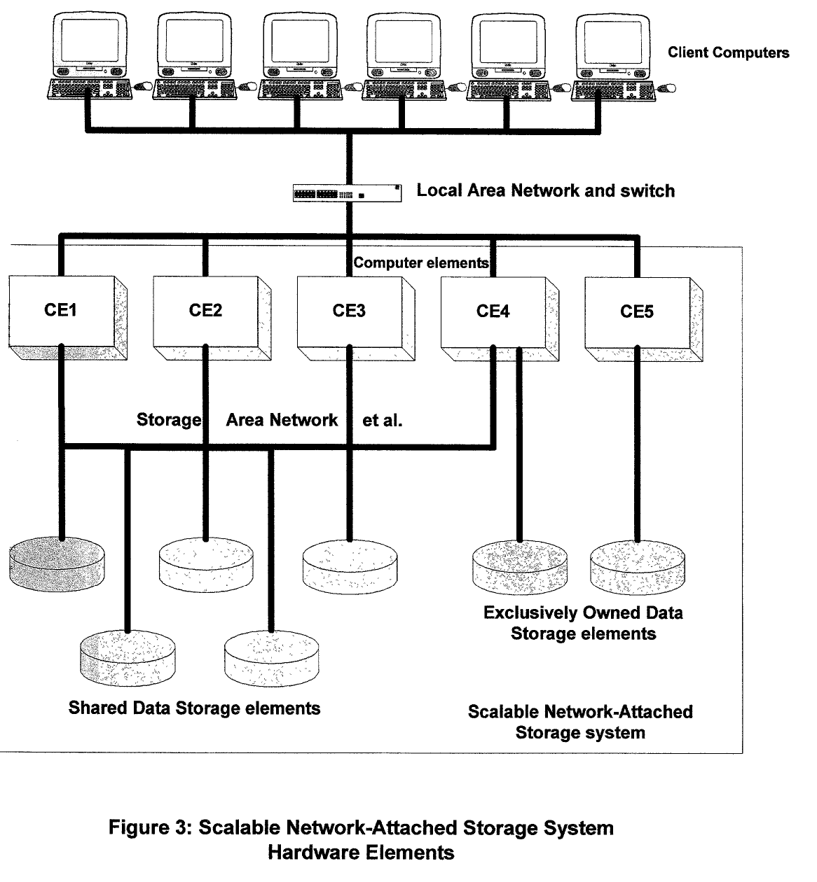

The invention is designed using a loosely coupled set of computer elements to take advantage of their much lower cost and higher flexibility (see FIG. 3). It differs substantially from current approaches by not requiring a shared file system. Instead the invention achieves data storage integrity and systems scaling by use of software elements that control allocation of access, which is inherently slow to change. It does not suffer from the performance penalty seen in the loosely coupled system architecture approach to NAS, where a shared file system is used.

The shared file system usually require copies of the file system to be maintained in every computer node, which must be completely synchronized at all times. This causes a great deal of overhead for each operation in accessing data, with throughput being reduced as much as 90%. Some of this type of system uses a central “lockbox”, where the status of every file is maintained, to attempt to reduce the performance penalty, but the gains involved are not significant, and the performance loss is even more pronounced as the number of computer elements is increased.

### Basic Operation

The invention consists of a number of software elements acting in concert, which are applied to the computer elements to form an SNAS system. In a typical implementation (see FIG. 1), these elements include:

a) Dynamic Allocation Controller (DAC)

This software element controls the allocation of segments of the storage pool to a given computer element. It utilizes a set of policy rules, based on templates as modified by the system administrator; to determine which data storage element (Drives, logical volumes, folders/directories, files or blocks) is controlled by which computer element. The data storage elements do not need to be contiguously mapped, since the architecture of the invention permits fragmentation of an element to the level of individual blocks. The DAC periodically updates the allocation of data storage elements as the metrics that control the policies change.

The DAC also provides the agency for handling the addition or subtraction/failure of either computer elements or data storage elements. In all cases, DAC includes the changes when updating the allocations according to the policies during the update cycles subsequent to the hardware change. A typical system will have a primary DAC, which is active, and a backup DAC on another computer element, which is inactive unless the primary DAC fails.

b) Access Re-Director (ARD)

The ARD acts as the initial connection point for the outside clients. This is the element that a client will contact to make (open) a new file access. The ARD finds the computer element that is actually handling the requested file and sends a redirection method to the client, which then communicates with the computer element directly for data transfers.

ARD has the capability of carrying multiple computer elements for any single data element. This allows scaling of throughput, multiplying the performance of the total SNAS system. Multiple ARD elements are allowed in a system, with one designated as primary, and another as first secondary. The reason for this is explained below.

c) Connection Monitor Agent (CMA)

CMA co-resides with the ARD element. It functions as a tracking agent for accesses to specific data element. As such, CMA provides a number of the metrics for use by the DAC in its policy calculations

d) Throughput Monitor Agent (TMA)

TMA co-resides with the NAS software in each computer element. It tracks performance relative to the capability of the computer element and reports back periodically to the DAC. The TMA also acts as a failure detector, since any unit that fails to update metrics is interrogated and action taken if it fails to respond.

e) Policy Administration Interface (PAI)

PAI is an administrator's interface tool that can sit on any computer connected to the SNAS system. It communicates via an encrypted connection to the DAC element, allowing policies to be modified. It contains a Task Scheduler, which permits events to occur at specific times. This permits sophisticated pricing methods for service quality and performance, since the DAC can schedule increasing the number of elements servicing a client's data, for example.

Other software elements can be added, including a Secure-SNAS capability, automatic Data Replication Agents, and Peer-Based Storage Networking services. These are discussed in the appropriate sections below.

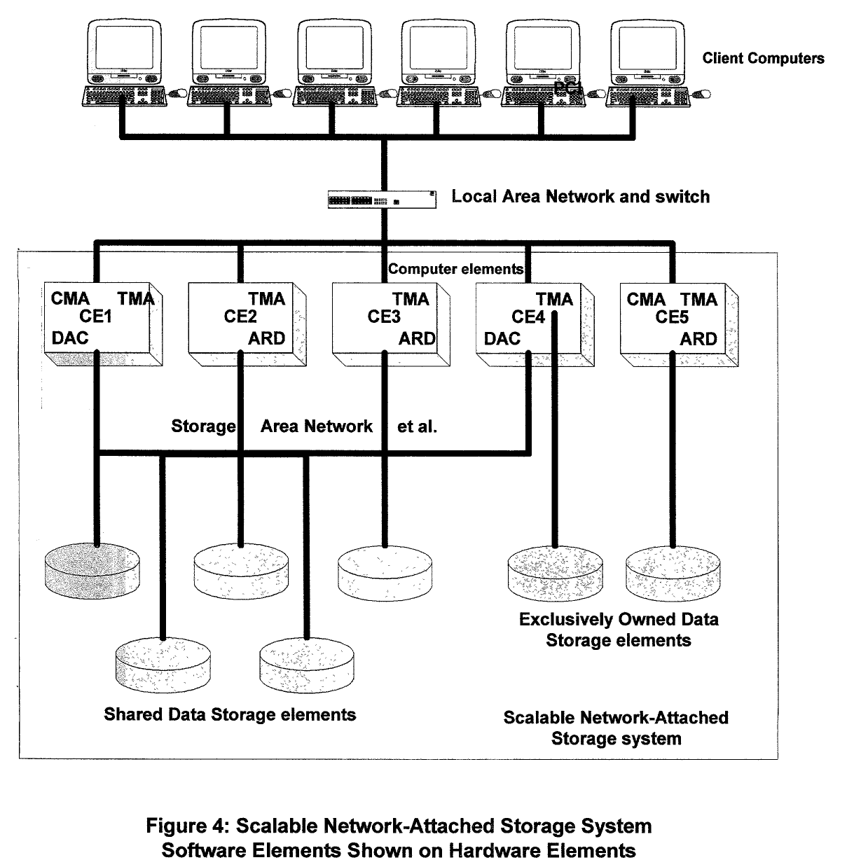

Referring to a typical implementation as depicted in FIG. 4, we see the aforementioned software elements deployed on a set of computer elements. To demonstrate the operation of this invention in this typical implementation, consider a client requesting a portion of a file from the NAS system. The following steps take place:

1. The client (PC2 in this example) issues an Open File request to the computer element (CE1) containing the ARD.

2. The ARD determines the computer element (in this case CE3) controlling that file, and transmits that information to PC2.

3. The client PC2 communicates the Open File request to CE3.

4. Ce3 verifies access permission to the requested data and acknowledges PC2's request.

5. PC2 begins to read data from CE3.

6. Upon completion of its accesses, PC2 informs CE3 to Close File.

Note that in FIG. 4, some of the data storage elements are shared by several computer elements using a Storage Area Network or similar means of sharing (including industry standards SCSI and i-SCSI, and any of a number of proprietary sharing solutions), while CE5 has exclusive ownership of its storage and CE4 has both shared ownership and exclusive ownership. This might occur when existing NAS installations are expanded with the scalable solution provided by this invention. In a situation like this, the access control for the exclusive storage elements would reside with the computer element to which they are attached, but the benefits of having a single policy control method and a virtual pool of storage when looking from the client end of the system provide strong advantages to the approach. This is a very important factor when the invention is expanded to provide a policy-driven Peer-Based Storage Network, since in this case many of the data storage elements will be exclusively attached to clients.

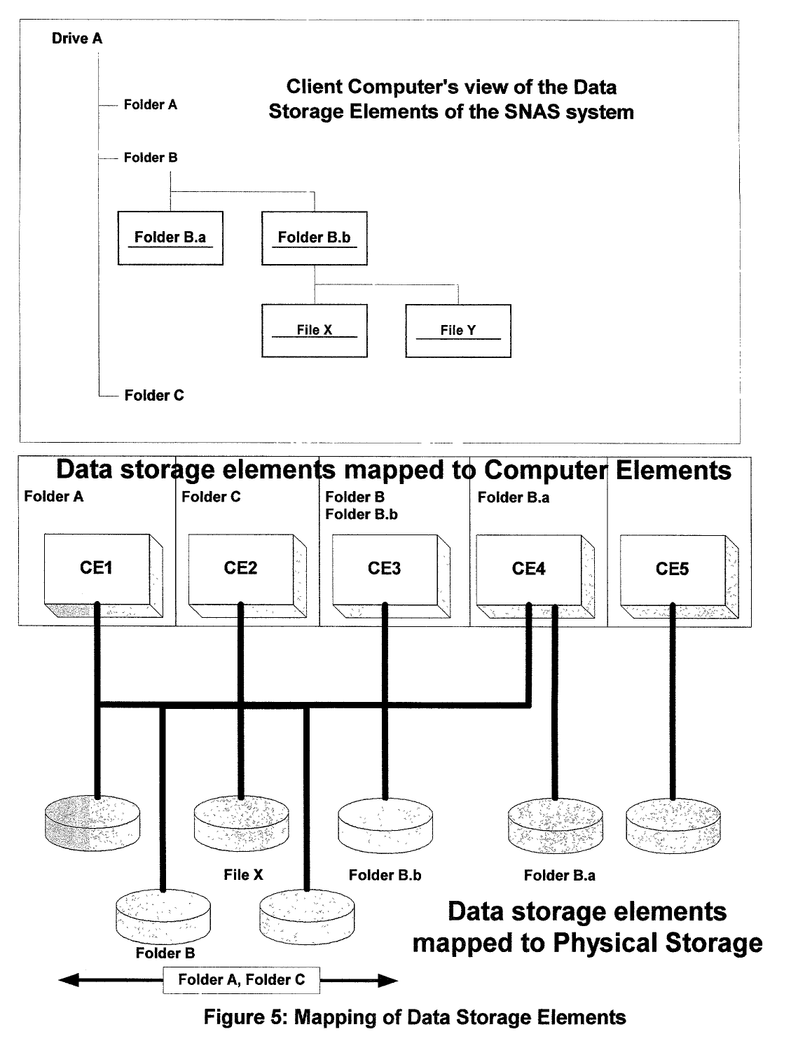

FIG. 5 shows how the typical set of data storage elements is mapped. On the top is the client's hierarchical view of the storage. This view sees a large single drive that is fragmented into folders, and then sub-folders then files, as in a typical file system. These folders are allocated to the various computer elements, as determined by the DAC software, resulting in every data storage element having at least one computer element referencing it. Finally, the allocated data storage elements are mapped onto physical storage devices, as shown on the bottom of FIG. 5.

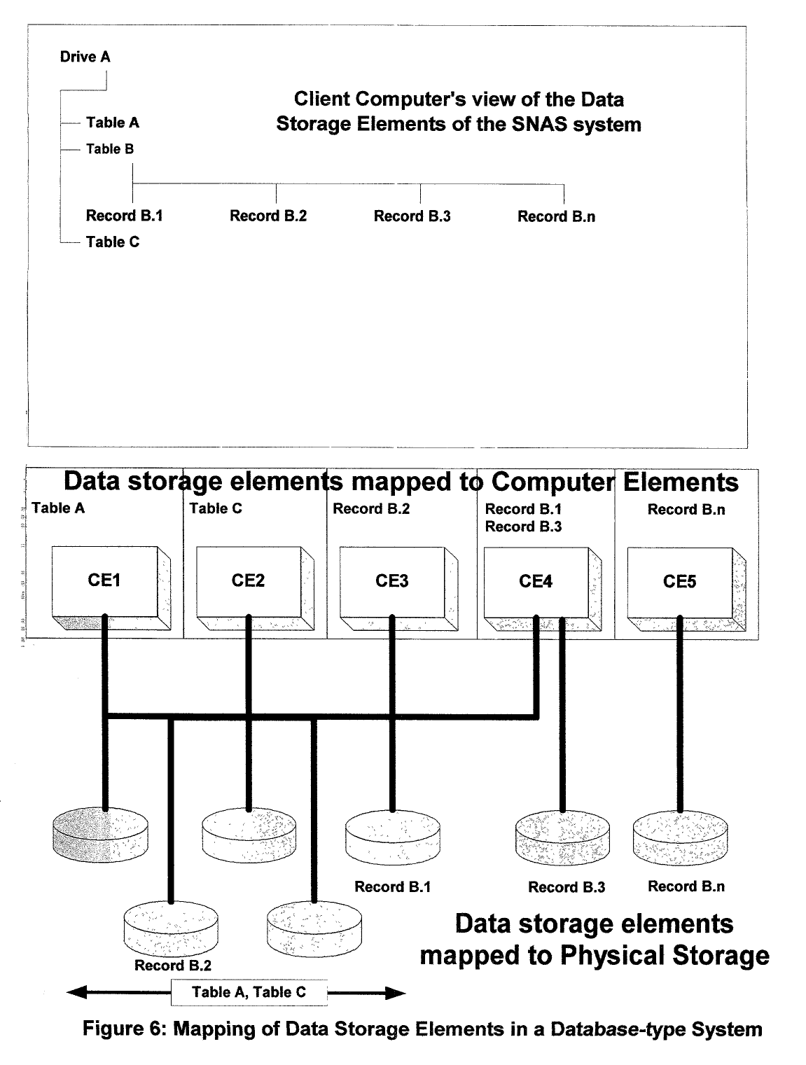

A database, table, record type system as found in relational databases can also be supported by the architecture of SNAS. This is schematically shown in FIG. 6, where it can be seen that the database, table and record elements replace the drive, folder/directory file elements. In this case, the database software and/or its associated operating system and software interface drivers may need a modification to allow data allocation to take place. Block level transfer systems such as i-SCSI can also be served by a version of the invention that responds to the i-SCSI operating protocol. In this case, sets of data blocks become the data storage elements.

Operations that increase or decrease the amount of storage used are more complicated in the type of system described herein than in a “standard” file system. The pool-of-storage concept underlying this invention implies central ownership of all the free space in the data storage elements. Though workable, this centralization presents a potential performance bottleneck, so in the preferred implementation the DAC uses a two-tier approach to free-space maintenance. Each mapped element has an associated free space allocated, so that many decisions to use free-space elements or return used elements to the free-space pool can be taken at the computer element level, rather than at the DAC level. A protocol is established where the computer element will request the DAC to make a change in free space allocated to its control whenever the computer element detects that its free space is outside the range of system policies.

Those operations that create or delete data storage elements can require additional steps to keep the mapping of data storage elements intact. The Create or Delete requests fall into one of two categories. In the simpler form, a request is received by a computer element and the affected entity is totally under the control of the computer element. An example of this is where a computer element completely controls a directory and is requested to delete a sub-directory. Here the Create or Delete operation proceeds without additional steps and is executed directly by the computer engine first receiving the request. If however the control of that parent data storage element were split between several computer elements and the data sub-element (the sub-directory in the example) were in fact controlled by another computer element, it would be necessary for the first computer element, which manages the parent element, to regain control of that sub-element prior to deletion. This is done by a request to the DAC, which re-maps the sub-element to the parent data storage element's computer element. Once the computer element controls the whole data storage element affected, it can make the deletion. When multiple computer elements manage a data sub-element the process is repeated for each computer element until there is a single owner at the parent element level.

### Scaling The Elements

The access allocation method described herein allows for very broad scaling of both data storage and throughput to the LAN. This is a direct result of an architecture where there is no need for real-time synchronization between file tables on many computer elements, which has been shown to cause performance losses of over 90%. As a result, NAS systems, which are currently either limited to two computer elements or that offer low performance in scalability, can be superseded by SNAS systems that are able to scale to very large numbers of computer elements, perhaps into the hundreds. It is worth noting that the independence of scaling between the data storage elements and the computer elements provides a major improvement in system administration.

Adding data storage elements is very simple with this system. Upon a computer element detecting that a new storage element is present, the DAC is notified and the new space added to the free-space pool.

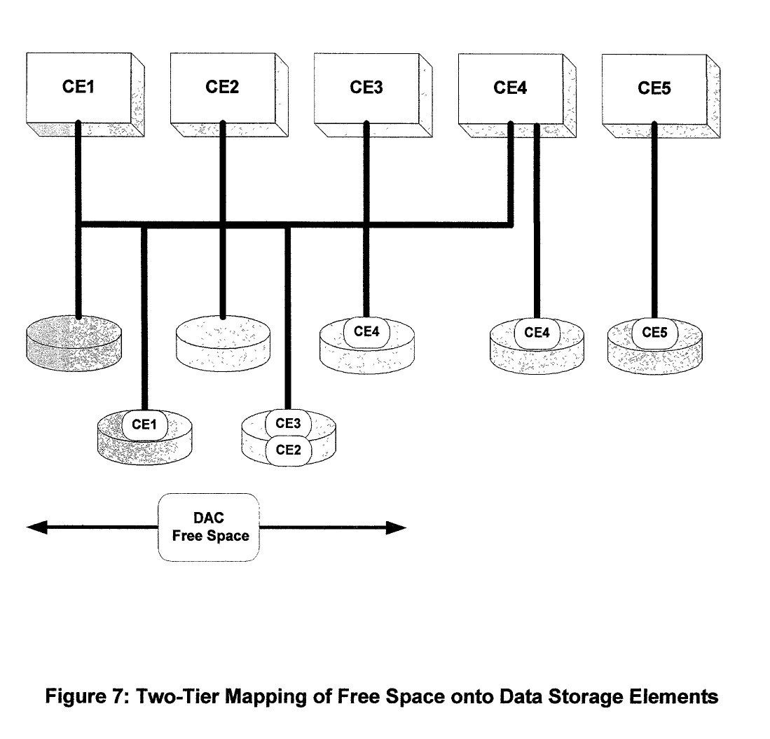

New computer elements are also easy to add (FIG. 7), since each new element will signify its presence through the TMA interface to the DAM. The DAC then applies its allocation policies to the expanded pool of computer elements, thereby balancing the load over the new elements.

Removal of an element is more complex. In the case of voluntary removal, the data on a data storage element is first copied to other elements using a utility tool. Voluntary removal of a computer engine requires the DAC to be notified so that the data storage elements allocated to the computer element that is being removed are available on other computer elements. In both cases, the request to remove can be achieved by a variety of methods including the PMI or other management software or by a physical method such as a pushbutton on the element.

### Fail-Over and Recovery

Involuntary removal or failure of an element creates the same challenges as in most computer systems. The easiest to deal with is the loss of a computer element. The TMA process detects this loss, when the failed element does not provide its regularly scheduled performance metrics. Recovery is relatively simple. The DAC rebuilds the access allocation map with the failed unit removed and the client operations timeout and retry to the new unit.

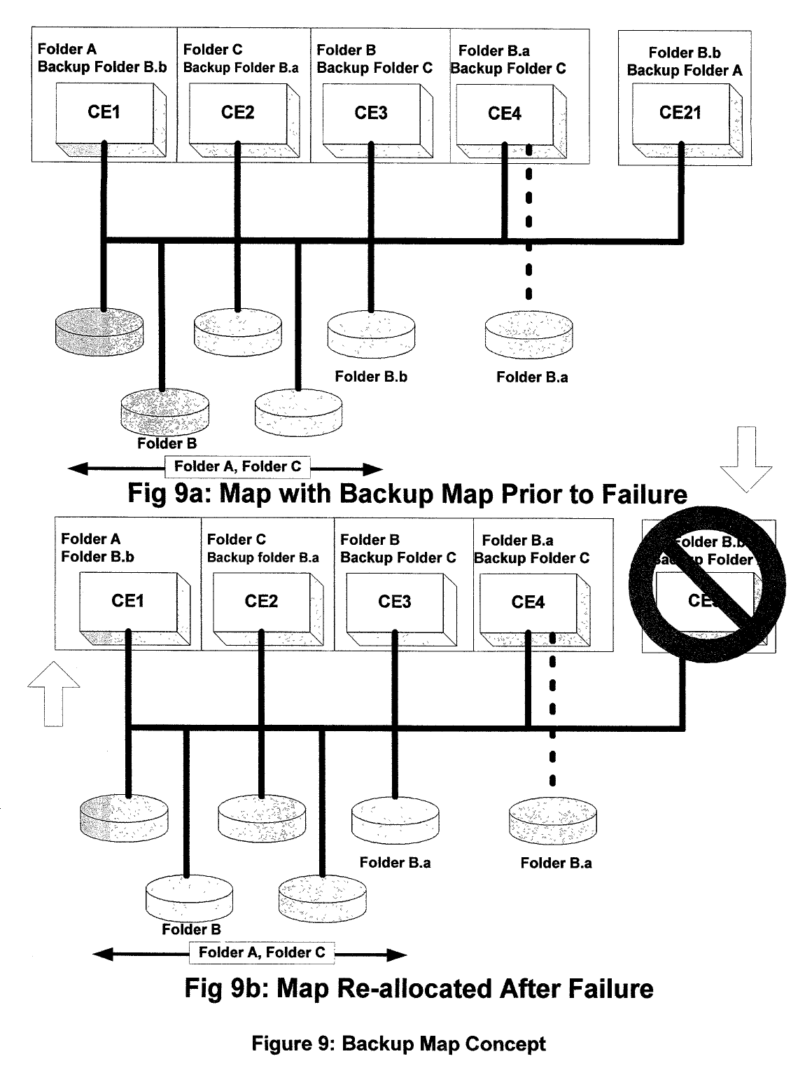

To minimize loss of data access and aborted client operations, pre-configuring an inactive backup computer element for each element that can quickly rebuild the file structure substantially speeds up recovery (FIG. 9). This inactive backup will normally be on a computer element that is actively controlling other data elements, though a dedicated backup is supported in the architecture. When a distributed backup system is used, the inactive backups are identified for all the active computer elements in such a way as that the failure of both active and inactive elements is very unlikely. The backups are mapped over the set of active computer elements to achieve this, so that typically each computer element has an active and a backup role. Since the inactive backups require minimal computer resources, the invention allows for multiple backups of any computer element. The instantaneous increase in load when the inactive allocation is brought on stream will be resolved relatively rapidly, as the TMA reports high loading to the DAC element, which then re-allocates the loading in the next few mapping cycles, load-balancing the system.

### Data Protection

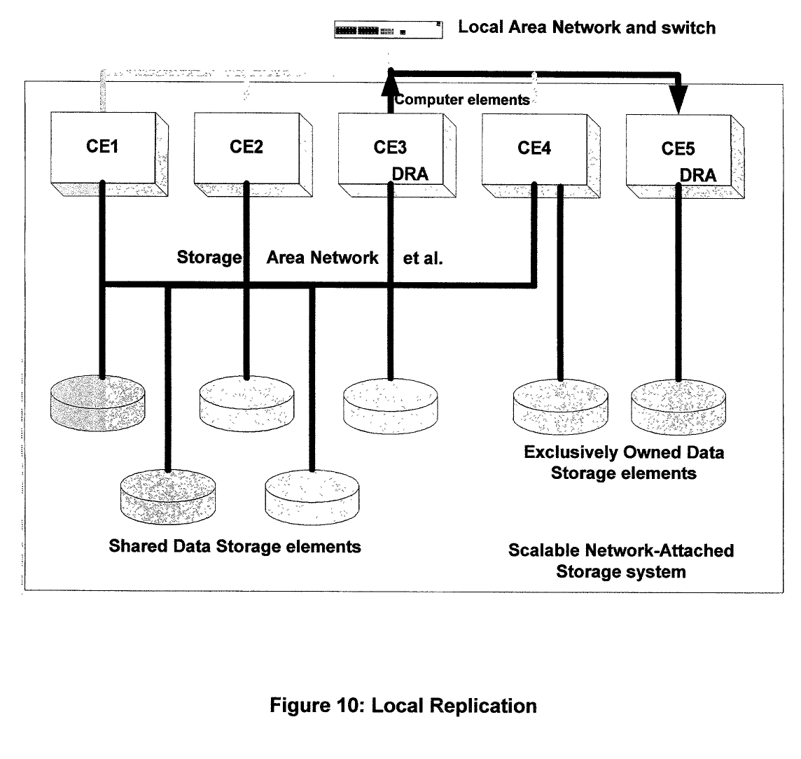

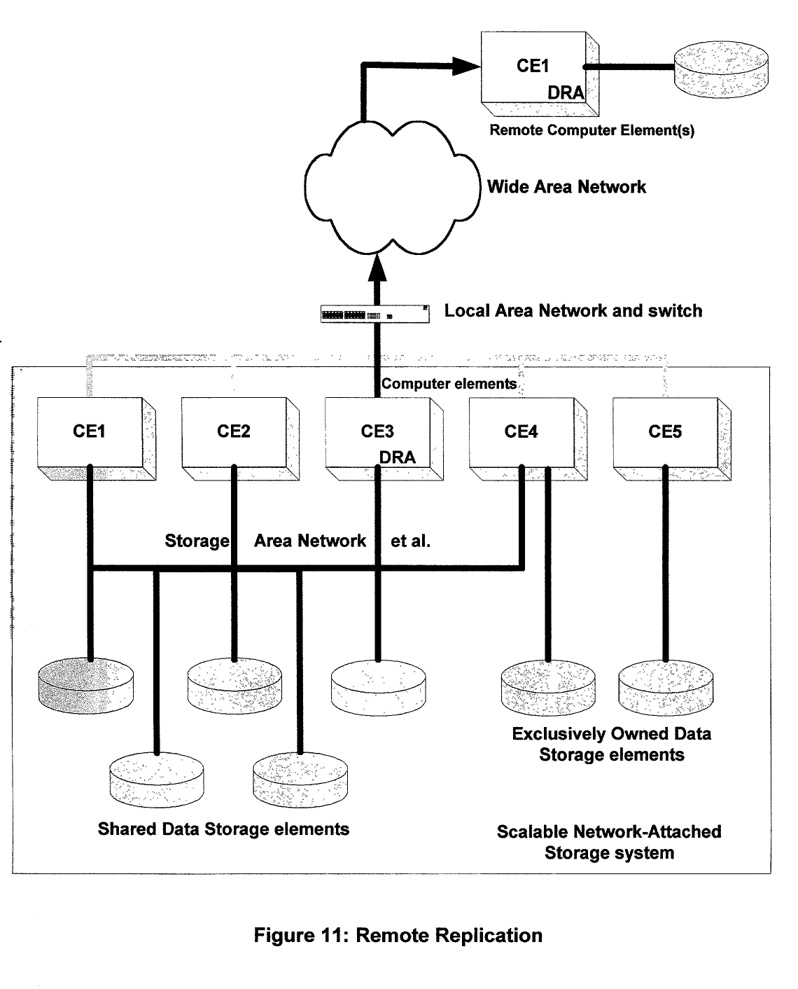

Protection against data corruption or loss in the storage require the same mechanisms as in most systems, including the use of RAID arrays and backup storage. A feature of the access allocation type system is a Data Replication Agent software element on each computer element that makes local and remote copies of any data storage element and/or backups according to policies downloaded from the DAM. This is shown in FIG. 10. Remote copies provide protection against a local disaster that might destroy or damage any copies in the local area (FIG. 11).

When a data storage element is modified by a computer element, the DRA checks to see if a copy of that new data is needed. If required, the DRA initiates a change to the appropriate replica or replicas of the file being changed. This is executed as a transaction between computer elements. The policy system may associate a variety of priorities to this replication, including immediate replication, delayed replication and the sequence in which the replication occurs within the total system.

### Access Replication

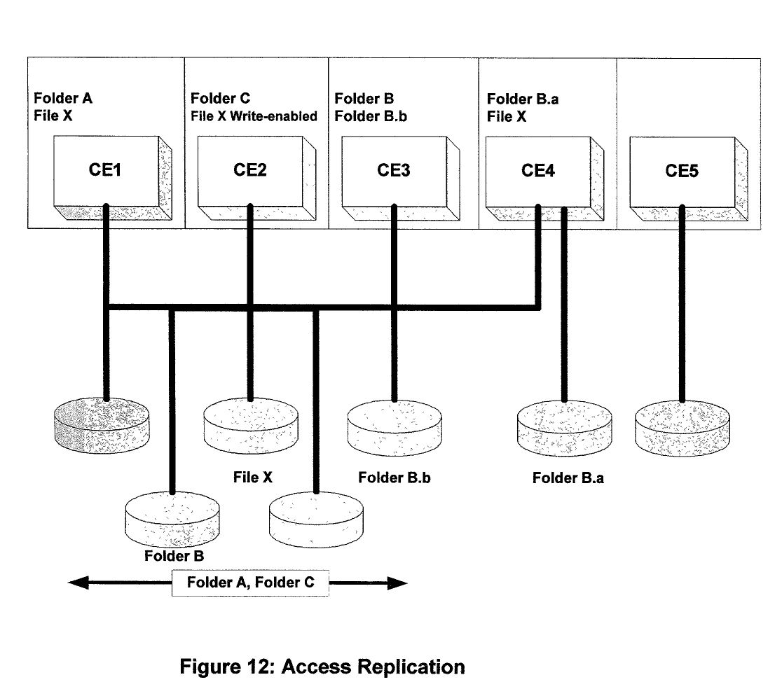

Another dimension of scaling follows from the concept of an inactive backup for a computer element. In many applications, a small set of files is very actively accessed. In this case, it is possible that a single computer element might prove incapable of supporting client demand. By making the inactive backup active (see FIG. 12), it is possible to effectively double throughput, though, for simplicity it is necessary to restrict write operations to just one node. With this restriction, it is, in fact, possible to have a large number of computer elements capable of addressing any give data storage element.

Access replication of this type can be used to minimize loss of availability of a section of the data storage elements through failure of a computer element, since the replicated computer elements can immediately service reissued requests from those clients originally communicating with the failed computer element.

### Secure-SNAS Systems

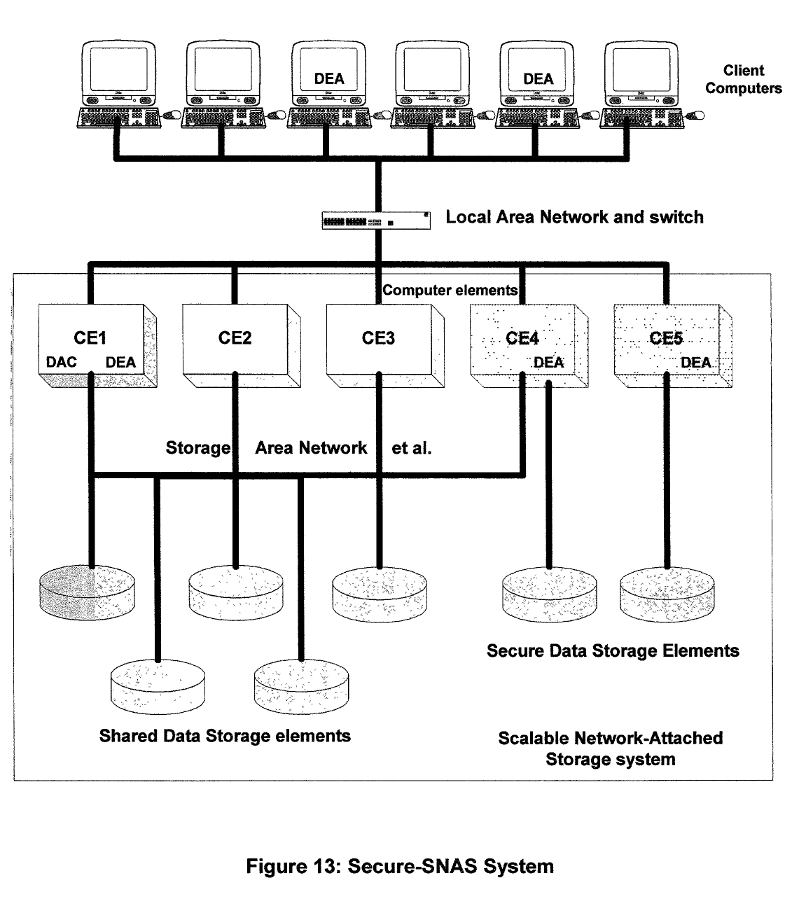

In any NAS system, unauthorized access to data is a serious concern. At a minimum, system administrators can access the files stored in a NAS system, and often users are very poor with password security. To overcome this, part of the structure of this invention supports a secure environment, which we are calling Secure-SNAS (FIG. 13). This environment is like the SNAS environment provided by this invention, but takes advantage of the invention's ability to segregate access to generate a sub-set of the storage that is encrypted at source by the user's client computer or user's server computer, and that can be accessed only by a sub-set of the computer elements of the invention.

As shown in FIG. 4, the Secure-SNAS and non-secure SNAS environments can co-exist with a Data Encryption Agent (DEA) being installed in those computers requiring encrypted storage capability. An extension to the DEA permits the user to establish a file policy system on that user's computer to determine whether any given file or data storage element should be replicated locally or remotely, and if and how it is encrypted. Additionally, the DEA provides the capability for encrypting command and control flows, including character padding on short messages, and for encrypting file structure information. The DEA may use hardware encryption assist capabilities if available.

### Peer-Based Storage Networks

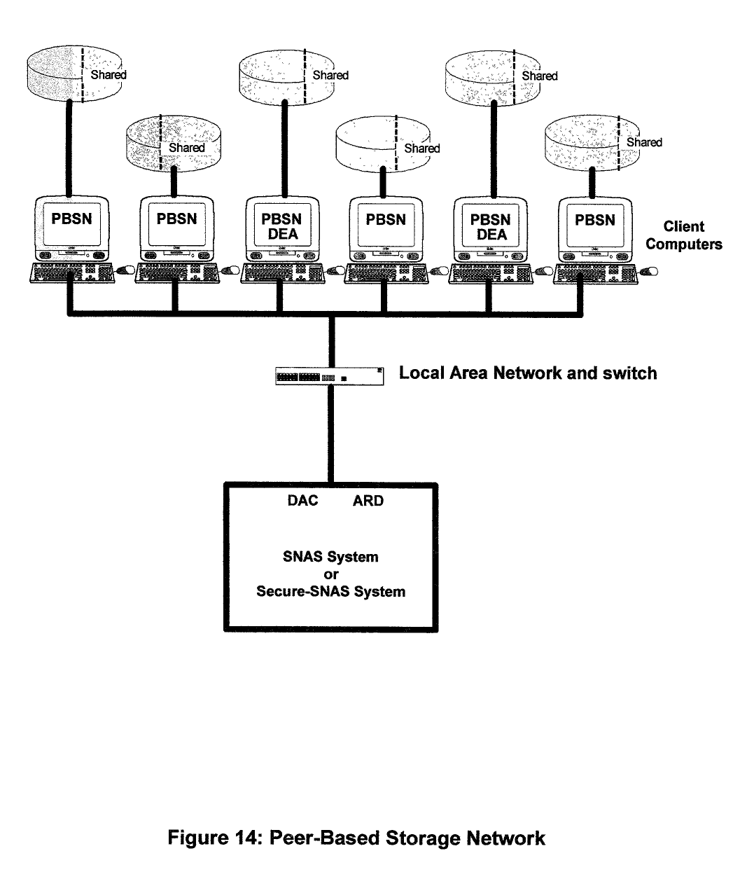

As the data storage capacities of hard disk drives have grown, the amount of storage unused in a network of Personal Computers or other computers has grown substantially, reaching levels comparable with large NAS storage systems. The invention described herein makes such a Peer-Based Storage Network (PBSN) possible by providing a vehicle for distributing storage across the data storage elements in such a network under the control of policy rule sets (See FIG. 14).

Each computer member of the network has a PBSN agent installed. This agent allows the user to set up a space in the computer's storage that can be shared with other users. The PBSN agent then sends the address and size information to the DAC via the LAN, and the DAC maps the computer into the PBSN as a computer element, and the defined storage as data storage elements. From this point, operation continues as in the NAS system developed from this invention and described above.

Should the user wish to disconnect some part or all of the storage, or extend the size of that storage, the PBSN agent provides an interface to the DAC. In that case where the storage is reduced, the DAC will move some or all of the stored files to other computers in the PBSN.

In this type of a network, security is a crucial issue. Normally the information stored in the PBSN space is encrypted at source using a Secure-SNAS element provided with the PBSN agent. This means the originator of that data has privacy control over it. Where the computer operating system supports the capability, the PBSN space on a computer is inaccessible directly by the users of that computer and/or is hidden from their view in normal operation.

A PBSN can extend to multiple remote locations, with policies controlling the placement of data at such remote locations. For example, all the important data at a site might be duplicated at several of the other sites and vice versa. In this case, too, replication policies can provide a local version of a remote site's files automatically, so speeding up access to shared data.

### High-Availability User Networks

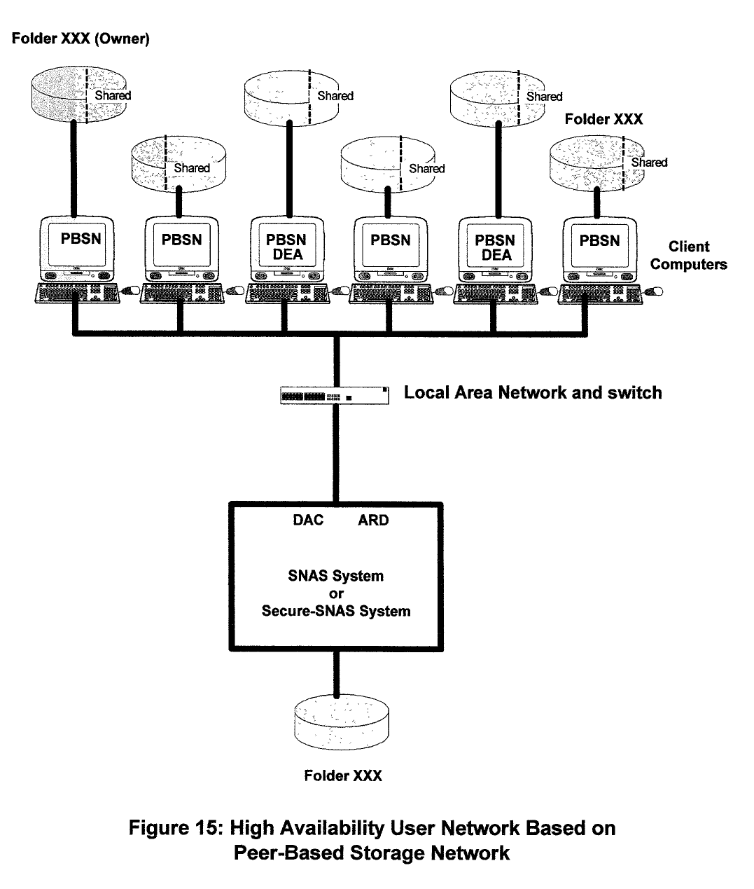

By extension of the PBSN concept, using the Data Replication Agent software element, a computer user can have, invisibly, multiple local and remote copies of the all of the user's important data made on the PBSN (see FIG. 15). By this means, any user that suffers a computer failure can access data immediately through any other computer on the PBSN. This method can be extended to encompass a full image of the user's working data, so that building a new computer can be accomplished in a very short time by simply copying that image from the PBSN to the new computer. These features are a part of the PBSN agent's Data Replication Agent function.

Since the DEA system uses very long encryption keys, which are not memorisable, to provide the encryption capability, it is necessary to provide a means to store these keys in case of the failure of a user's computer. A number of methods are available to achieve this, ranging from physical keys such as security cards, smart cards or keys or even microchips embedded under the skin, to logical access systems using passwords or lookup files, among other means. Several of these means have some level of security exposure. The DEA and the other software elements of the invention are designed to support a variety of these means, allowing for different levels of security in the installed product.

### Alternative Implementations of the Invention

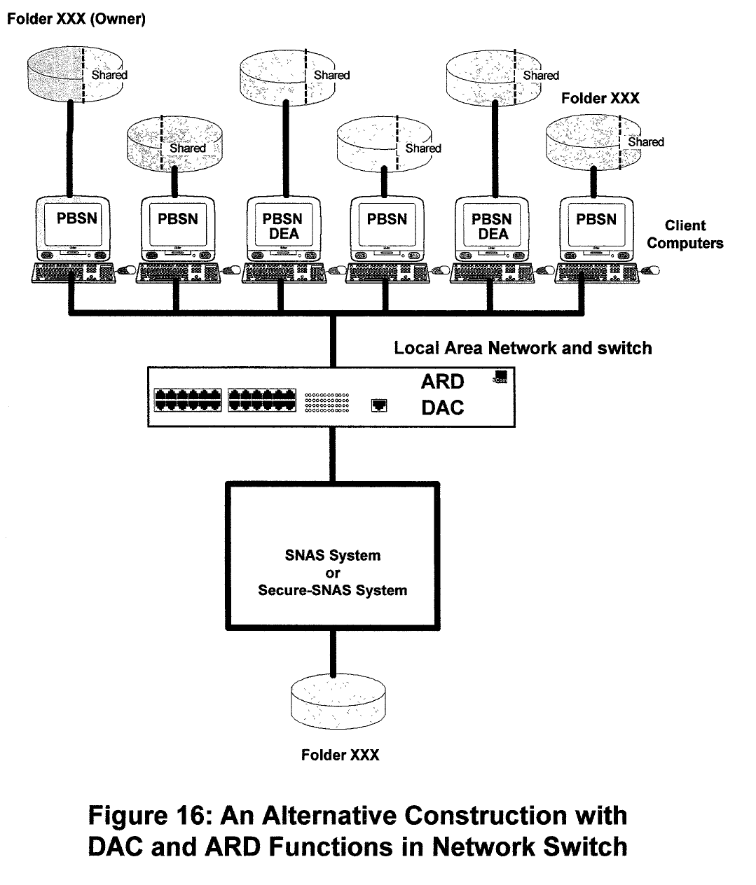

An alternative method (FIG. 16) of building the SNAS system is to install the DAC, the ARD and some of the other software facilities on a network switching device, such as a SAN, LAN or Wide Area Network switch, hub or router; so effectively making the redirections within that switching device and effectively invisible in most circumstances to the client computers.

What I claim are:

1) A means of building a Scalable Network-Attached Storage system where control of the data storage elements of said system is distributed over the computer elements of said system, so allowing said computer elements to access and control said data elements in a shared fashion whereby:
a) Control of the data-storage sub-elements of a data storage element can reside in different computer elements, so allowing large numbers of computer elements to be used in the Scalable Network-Attached Storage system, and so allowing said system to be easily and economically expanded in size and performance and reconfigured to needs;
b) Control of any such data storage sub-element can be replicated in several computer elements in such a way that these several computer elements can access said data sub-elements;
c) Allocation to the set of computer elements of said control of access to said data elements and data sub-elements is initially established by a software functionality according to a set of user and computer generated policy rules; and where said software functionality adjusts said distribution of access control across said computer elements on a periodic basis, depending on metrics measured periodically throughout the Scalable Network-Attached Storage system
d) Computer elements are specifically designated as the initial contact point for a client computer to the Scalable Network-Attached storage system, which designated computer elements have a software facility to determine that computer element having control of the data storage element that said client computer wishes to access and by means of said software facility re-direct said client computer to communicate directly with that computer element;
e) Where the software facility of paragraph c) in claim 1) above detects the addition of new computer elements to the Scalable Network-Attached Storage system via the periodic metrics transmitted to said software facility by said new computer element; and thereby said software facility re-maps the allocation to said computer elements of access control of said data storage elements to make use of said new computer element; and where the loss of a computer element through failure or removal is detected by a loss of periodic metric data, so causing said software facility to re-map the allocation to the remaining computer elements of access control of those data storage elements previously controlled by said lost computer element;

2) An extension of the means of claim 1) where temporary loss of access to said data storage elements is reduced by having a prepared backup map of the Scalable Network-Attached Storage system, whereby another backup computer element, which is configured to rapidly take control of said data elements, is designated for each computer element in such a way that a hardware or software failure will not affect both said computer element and its designated backup simultaneously; so that a failure detected by the software facility in Para e) of claim 1) will cause that software facility to move control to said backup computer element;
And where said backup computer element may be a computer element or one of a set of computer elements specifically and solely functioning as backup computer elements;
Or where said backup computer element may be a computer element that is actively controlling access to other data storage elements.

3) An extension to the means of claim 1) where the performance of the Scalable Network-Attached Storage system is increased by mapping multiple computer elements to be able to control any given data storage element;
Where one of said controlling computer elements is designated as the sole computer element allowed to change said data storage element, with the other computer elements being able to read said data storage element; or where the type of data storage element or the client computers' method of accessing same permits multiple computer elements to change said data storage element.

4) An extension to claim 3 whereby the ability of the system to recover from a failure is enhanced by having a data replication software facility which allows a computer element to replicate data according to policy rules managed by the system, with said replication being to both local computer elements who store such replicas on the data storage elements under their control, or to remote computer elements, permitting copies of data to be at a safe distance to protect against natural or man-made disasters;
And where said data replication software facility may also be used to provide copies of data at the remote site or sites for said remote site or sites to be able to access data more rapidly than if it were at the originating site;
And where the said policy rules for replication may include schedule, frequency and priority of replication, number of backup copies, type of backup data storage elements and other policy rules.

5) An extension of claim 1 above whereby a two-tier system is used to mange unused free space in the Scalable Network-Attached Storage system and its derivatives, such two-tier system being implemented as a software facility that provides both a means to allocate part of the available unused free space to each computer element, keeping the remainder under its own control, and which software facility uses policy rules to monitor, control and change this allocation periodically based on metric information reported to said software facility by the computer elements.

6) An extension to the means in the above claims whereby a set of the data storage elements and computer elements in a Scalable Network-Attached Storage system are designated as a Secure Scalable Network-Attached Storage system, with the data storage elements being encrypted by the client computer, and with the file structure of said data elements being encrypted, and with communications between the client systems and the Scalable-Network-Attached storage system being encrypted.

7) An extension to the means in the above claims whereby those means are employed to take advantage of data storage elements in the client computers by using said data storage elements in part or in whole as data storage elements in a distributed form of Scalable Network-Attached Storage (here named Peer-Based Storage Network), where
a) The data storage elements in any given client computer can be shared with other client computers under the control of the Scalable Network-Attached Storage software forming this invention, as extended to provide the Peer-Based Storage network capability, and with the features of replication and security as claimed above and described herein;
b) Where software facilities are provided to allow designation of the amount of said data storage elements a client computer may wish to share; with software facilities to increase or decrease said amount as desired without causing loss of data to the client computers sharing the data storage elements being changed;
c) Where replication and backup policies may be developed to protect automatically against loss of a client computer and/or its stored data on its data storage elements

8) An alternative construction of the invention whereby the computer elements of the Scalable Network-Attached Storage system, Secure Scalable Network-Attached Storage system or Peer-Based Storage Network in part or in whole are replaced by a storage network switching element or a local area network switching element or a communications switching element.
